(19) United States
(12) Patent Application Publication
(10) Pub. No.: US 2009/0008194 A1
(43) Pub. Date: Jan. 8, 2009

(54) Disc Brake

(75) Inventors: Bernward Redemann, Hockenheim (DE); Eugen Kloos, Bensheim (DE); Peter Blatt, Morlenbach (DE); Paul Antony, Worms (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WABCO RADBREMSEN GMBH, Mannheim (DE)

(21) Appl. No.: 11/576,839

(22) PCT Filed: Oct. 13, 2005
(86) PCT No.: PCT/EP05/11043

§ 371 Date: Apr. 6, 2007

(30) Foreign Application Priority Data
Oct. 15, 2004 (DE) 10 2004 050 349.4

(51) Int. Cl. F16D 55/225

(52) U.S. Cl. 188/73.32

(57) ABSTRACT

Embodiments of the present invention provide a disc brake, comprising a brake support, a brake caliper, a brake disc and at least one brake lining. According to embodiments of the invention, in the assembled state of the disc brake, the brake support comprises no component extending over the brake disc and/or extending into the rotation contour of the brake caliper or extending over the rotation contour of the brake caliper, and the brake caliper comprises an opening through which the brake lining passes for assembly/disassembly.

The invention relates to a disc brake, comprising a brake support, a brake caliper, a brake disc and at least one brake lining. The invention relates specifically to a disc brake for commercial vehicles.

It is a known approach to attach drum brakes to an axle assembly for their brake support serving as a fixed portion, and usually an axle head with the respective design or a ring flange is used for this purpose. For this reason, the axle head/ring flange as well as the brake support exhibit recesses which are frequently arranged on an imaginary pitch circle. The actual attachment is effected by the use of axial screw connections.

In the event that the drum brakes are to be replaced by disc brakes without modification of the parts of the axle head/ring flange serving for the attachment, so-called adapters are traditionally used, with such an adapter serving as intermediate part being attached to the axle head or the ring flange with the above-mentioned axial screw connections.

The pre-assembled disc brake is then installed onto the adapter, by attaching the brake support of the disc brake to the adapter, also using axial screw connections. Since brake supports that are frame-shaped and extend over and engage behind the brake disc are traditionally used to support the brake linings of the disc brake, the installation is not possible until after the completed assembly of the brake disc to the axle assembly.

The installation of a disc brake by means of an adapter is known, for example, from WO 01/42676.

The adapter constitutes an additional part, which increases the axle weight, the installation length and the assembly/disassembly expenditure.

U.S. Pat. No. 4,319,668 as well as EP 0 143 941 B1 have already presented disc brakes which do away with an adapter. In these solutions, however, parts of the respective brake supports extend over the brake disc in the assembled state.

In neither of these solutions is it possible to install, as an assembly, a disc brake that is pre-assembled to the greatest extent possible. Instead, all brake parts have to be installed one after the other on the axle assembly because otherwise it would either be impossible to install the brake disc or the already mounted brake disc would render a complete installation impossible.

Therefore, the invention is based on the problem of improving the disc brake, as it is known e. g. from EP 0 143 941 B1, to the extent that the assembly/disassembly expenditure is reduced, yet maximum braking forces are still capable of being transmitted.

According to the invention, this problem is solved by having a brake support which does not exhibit any parts which, in the assembled state, extend over the brake disc and/or the rotation contour of the brake caliper, and by having a brake caliper which exhibits an opening through which the brake lining passes for assembly/disassembly.

The disc brake in accordance with the invention makes it possible to push the maximally pre-assembled disc brake, consisting of, for example, the brake support and the brake caliper, directly from the outside against the axle assembly while the brake disc is not yet installed, and to screw it together with the axle assembly. Since, at this time, the brake linings do not have to be installed yet and the brake support exhibits no parts extending over the brake disc in the assembled state (i. e. has a “plate-shaped” design, so to speak), the brake disc can then be installed without any problems (for example using a temporarily inclined position). Then the brake linings are installed through the opening in the caliper. Overall, this results in a very simple assembly process.

In addition, the exchange of the brake lining is especially easy because the linings can simply be removed through the opening and exchanged for new linings. It is not necessary to disassemble the entire caliper.

Within the framework of the invention, “rotation contour” of the brake caliper designates the contour of the brake caliper in the projection parallel to the axis of rotation of the brake disc. In accordance with the invention, the brake caliper extends over the brake disc. In this configuration, the rotation contour has to be such that the brake caliper still fits into the wheel rim bed or the wheel rim well of the wheel to be braked. In the event that it should be possible for maximum braking forces to be transmitted, the brake disc, on the one hand, has to have a maximized diameter for reasons of the law of the lever. That is why the rotation contour of the brake caliper should also be at a maximum radial distance from the axis of rotation of the brake disc. On the other hand, the brake caliper has to be dimensioned such that it has the required strength for the transmission of the braking forces. But the dimensioning of the caliper is determined or limited by the free space between the wheel rim bed, on the one hand, and the outer contour of the brake disc, on the other hand. If other brake parts, such as e. g. parts of the brake support, extend into this free space, the brake caliper has to be adapted to these brake parts in its design dimensions. For example, it can no longer have the maximum radial extension with respect to the size of the wheel rim bed. This adaptation of the caliper thus adversely affects the strength of the caliper and therefore limits the maximum transmittable braking force. An embodiment of the invention therefore provides that the brake support, in its assembled state, does not exhibit any parts that extend into the rotation contour of the brake caliper and/or extend over the rotation contour of the brake caliper.

With a given size of the wheel rim bed, this allows for the radial maximization of the brake caliper and hence the brake disc, resulting in maximum braking forces. Moreover, it is possible for the brake caliper to have a compact design relative to the caliper width and its cross-sections, even when a large brake disc is used.

In accordance with a specially preferred embodiment of the invention, it is provided that the brake support exhibits a flange surface intended for the attachment to an axle assembly, with the flange surface to be formed in an area which encompasses the axis of rotation of the brake disc in the form of a closed contour. This closed contour results in an increased stability. The other way around, the thickness of the area of the brake support exhibiting the flange may be reduced, preserving the same stability, with this resulting in a savings of installation space. In addition, the brake may be attached to the axle assembly in various angle positions. An adapter is unnecessary.

According to the invention, it may be alternatively provided that the brake support exhibits a flange surface for the attachment to an axle assembly, with the flange surface being formed in an area which exhibits a recess for the placement on top of an axle stub in the transverse direction to the axis of rotation. In other words, the flange surface in this solution is “C” shaped or “U” shaped, depending on the contour of the opening. In some installation situations, the placement on top of the axle stub in the transverse direction to the brake axis is easier than the sliding onto the axle stub in the axial direction (which is required given a closed contour). Again, an adapter is unnecessary.

Preferably, at least one recess is provided in the flange surface.

Such a recess can serve various purposes. In accordance with a specially preferred embodiment of the invention, it is provided that the recess serves to accept an attachment screw or a sensor. The attachment screw may be screwed directly into a threaded hole or it may be held by a nut.

If it serves to accommodate an attachment screw, a decision has to be made, depending on the overall situation, as to whether the attachment screw will be screwed in from the side of the brake disc or the side of the axle.

The above-mentioned sensor may be, for example, an ABS (antilock brake system) sensor or a speed sensor. The provision of the respective recess for accommodation in the flange surface results in an overall minimized installation space.

Preferably, the flange surface is on the side of the brake support that is facing away from the brake disc. In this respect, the invention differs from, in particular, the above-mentioned U.S. Pat. No. 4,319,668, where the flanging is effected from the middle of the vehicle. In accordance with this preferred solution of the invention, installation to a guided axle is also possible because no parts of an axle leg are in the way, hindering the installation.

In accordance with a further preferred embodiment of the invention, it is provided that the brake support exhibits a device for the detachable attachment of a guiding device for the brake caliper.

This solution offers a great advantage especially in the case of brakes with floating calipers.

The attachment device preferably exhibits at least one recess to accommodate a guiding element. The formation of a recess is particularly simple, resulting in a simplification of the overall configuration.

In accordance with an especially preferred embodiment of the invention, the guiding device exhibits at least one guide bolt. Such a guide bolt is suited to reliably guide the floating caliper without it being necessary for parts of the brake support to extend over or even behind the brake disc.

Preferably, at least one guiding projection, located on the side of the brake support that is facing away from the brake disc, is provided to guide a pressure plate of the brake. The provision of the guide on a projection of the brake support that is facing away from the brake disc enables a comparatively thin design of the brake support, allowing a savings of material and thus weight.

In other words, the brake support may have a “plate-shaped” design although the pressure plate is guided along a certain axle length.

Preferably, a guide groove is provided on the guide projection, implementing a particularly simple concept because only a molding blank of the brake support, exhibiting a guiding projection, has to be manufactured using casting. After that, the guide groove may be created on the guide projection without extensive effort, for example using a milling process.

In accordance with the invention, a first guide projection is provided on the disc inlet side and a second guide projection is preferably provided on the disc outlet side. This design allows for the possibility of designing the brake support for brakes located on the left side and, at the same time, for brakes located on the right side, for the guide groove has to be created on the respective side only at the time when the final decision on the installation side of the guide groove is made. Certainly it would also be possible to provide two guide grooves, which would make the brake support capable of being optionally installed on the right or on the left side. The guide groove on the disc inlet side is preferably disposed inclined at an angle against the disc inlet.

In accordance with the invention, a stop to restrict the shift of the brake caliper in the axial direction of the brake disc is preferably provided. Such a stop serves, for example, to prevent the brake caliper from either crushing a protective cap of a sliding bolt or lifting it out of its holder, depending on the direction in which the brake caliper could be excessively shifted. But excessive shifting of the brake caliper could also have other adverse consequences. Such an excessive shift is, however, limited by the stop in accordance with the invention.

Furthermore, the invention provides that the brake caliper exhibits two caliper legs located on opposite sides of the brake disc and one connection device connecting the two caliper legs with each other, with the connection device being radially closer to the brake disc on a brake disc outlet side than on a brake disc inlet side, at least in the area in which it extends over the brake disc.

This enables the caliper to transmit high brake application forces without expansion and without the occurrence of losses and to move along, within the preset elasticity range during braking, in the direction of the preferred direction of rotation of the disc, without this giving rise to a danger of a collision between the brake disc or a wheel rim surrounding the brake. There is also an equilibrium of moments which provides relief of the guide bolts and thus relief of the plate-shaped brake support, which is especially advantageous in the brakes of commercial vehicles.

In accordance with an especially preferred embodiment of the invention, it is provided that a brake lining on the side of the wheel rim is coupled with the brake caliper in such a way that the brake caliper serves to transmit braking forces from the brake lining on the wheel rim side to the brake support.

This eliminates the need for parts—apart from the brake caliper—which extend over the brake disc in order to conduct the braking forces into the brake support and finally into the axle assembly.

And finally it is preferred, in accordance with the invention, to make the brake support in one piece.

In other words, to transmit the braking forces, there is only one component, i. e. the brake support made in one piece, between the brake caliper, if necessary guided on guide bolts, and the brake lining on the actuation side, on the one hand, and the axle assembly, on the other hand. This simplifies the assembly/disassembly, on the one hand, and produces other mechanical advantages, on the other hand.

In the following, the invention will be explained in more detail using examples of preferred embodiments and by reference to the attached drawing. In the drawing:

FIG. 1 is a schematic perspective view of a brake support in accordance with a preferred embodiment of the invention.

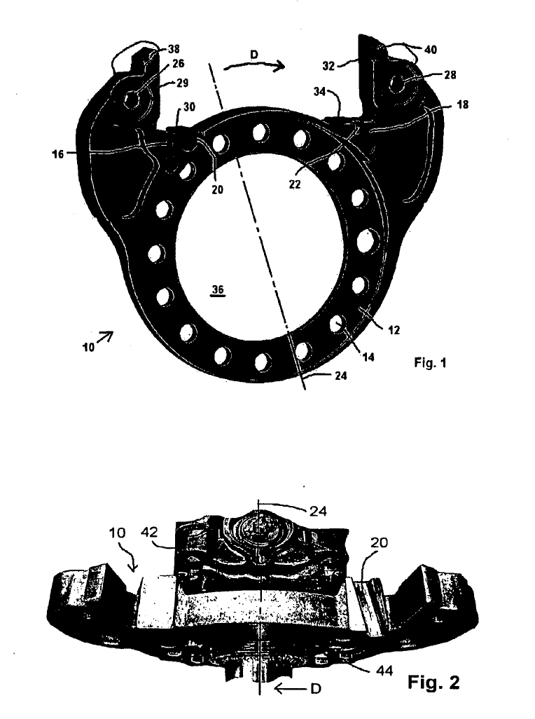

FIG. 2 is a top view of a different embodiment of the brake support according to the invention, in the assembled state, assembled to an axle assembly.

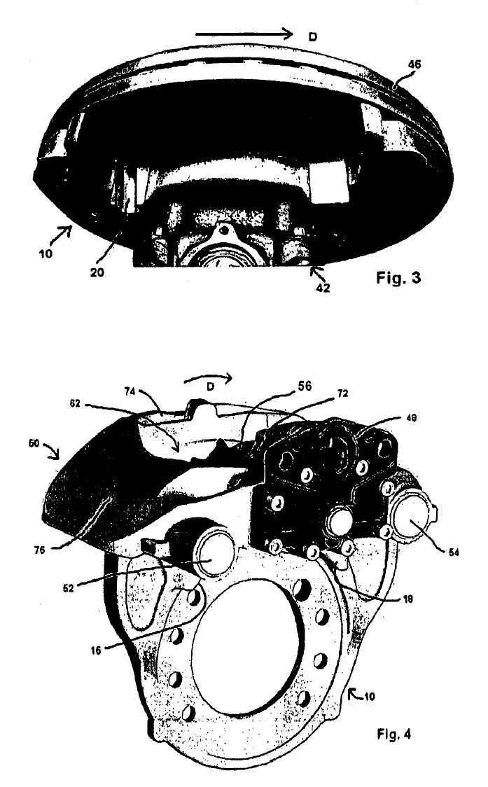

FIG. 3 is a view of the brake support according to FIG. 2, with a brake disc additionally installed.

FIG. 4 is a schematic view of a pre-assembled disc brake in accordance with an embodiment of the invention as an assembly.

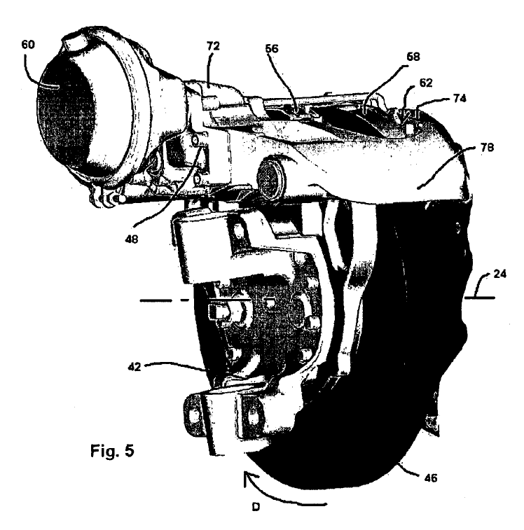

FIG. 5 is a schematic perspective view of a disc brake in accordance with a preferred embodiment of the invention, in the assembled state.

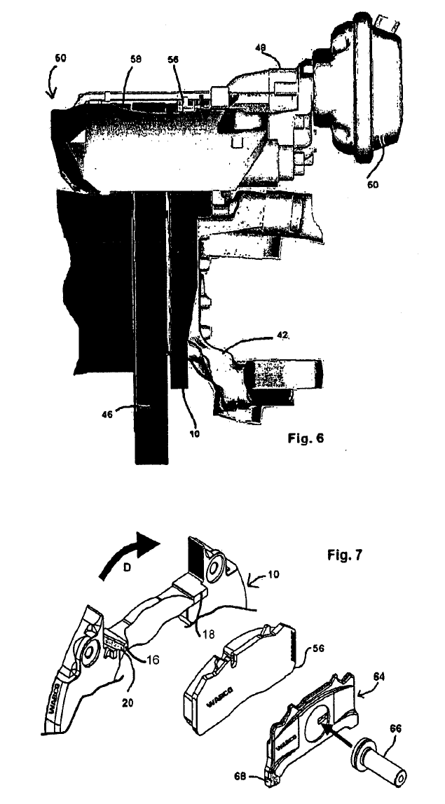

FIG. 6 is a side view of the disc brake in accordance with FIG. 5.

FIG. 7 is a schematic explosion view of parts of an embodiment of the disc brake in accordance with the invention, including a pressure plate, and

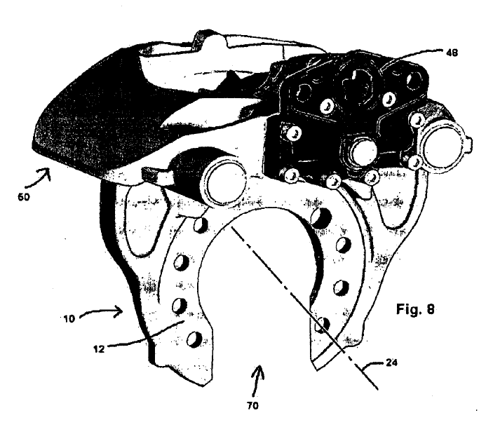

FIG. 8 is the same view as FIG. 4, but of a different embodiment of the invention.

FIG. 1 shows a brake support 10, with a view of a flange surface 12, with said brake support resting against a corresponding area of an axle assembly in the installed state. It exhibits a number of openings, one of which is provided with a reference number 14 to serve as an example. The openings serve to accommodate axial attachment screws used to attach the brake support to the axle assembly. If necessary, one of the openings may serve to bear an ABS and/or speed sensor. The brake support is essentially plate-shaped. On its side facing the axle assembly, only two projections are provided which protrude beyond the flange surface 12. In contrast, the brake support 10 has no parts or areas which could protrude on the opposite side of the flange surface 12, in particular no parts which extend over or even behind a brake disc placed in that location. On the projections 16 and 18, a guide groove 20, 22 is provided, respectively, to guide the pressure plate. The guide grooves 20, 22 are disposed inclined against the disc inlet, relative to an axis of rotation 24, which results in considerable advantages with respect to a pressure plate suspended into such a guide groove. In view of the direction of rotation D during forward travel, shown in FIG. 1, the pressure plate is suspended only on the side that is shown on the left in the figure.

The brake support 10 exhibits two openings 26, 28 with snug fit, serving to accommodate the sliding bolts to guide the brake caliper. This is explained in further detail below. The guiding surfaces 29, 30, 32, 34 serve to guide a brake lining which is also described in further detail below.

The flange surface 12 circumscribes an annulus and thus has a closed contour. It surrounds an axle opening 36. This axle opening serves to accept an axle stub when flanging to an axle assembly. During the installation of the brake support, the above-mentioned axle stub may serve as a certain centering aid. In addition, particularly the projections 16 and 18 serve as assembly aids because the brake support may be placed on the axle assembly at least temporarily via the projections 16 and 18, in order to then install the axial connection screws in the openings 14.

The projections 38 and 40 serve as stops to limit the axial movement of the caliper in order to protect the above-mentioned bolt guide or its casing from being crushed or lifted out of its attachment.

FIG. 2 shows a somewhat modified brake support 10 in the assembled state. One can see an axle assembly 42 and the guide groove 20. The guide groove 22 shown in FIG. 1 is not provided. The attachment to the axle assembly 42 is effected using axial screws. One of these screws is identified in an exemplary fashion with the reference number 44. For clarification purposes, it is hereby noted that the middle of the vehicle is on the top in FIG. 2.

FIG. 3 shows another view, with the middle of the vehicle on the bottom. In the view shown in FIG. 3, not only the brake support 10 is mounted to the axle assembly 42, but also a brake disc 46 is installed. Especially FIG. 3 very clearly shows that no part of the brake support 10 extends over or even behind the brake disc 46. The brake support 10 thus merely serves to support and guide the pressure plate and a brake lining on the actuation side, while a brake lining on the wheel rim side is not supported and guided by the brake support but rather by the brake caliper. Due to the fact that the brake lining on the wheel rim side is supported only by the brake caliper, there are no parts necessary on the brake support that radially extend over the outer contour of the brake disc and the rotation contour of the brake caliper. p Thus the brake caliper may be positioned close to the wheel rim bed. This allows, for example, a bigger brake disc and thus an increased braking power. On the other hand, this construction also provides for the option of installing the disc brake in a not completely pre-assembled state because no multiple screw connections of the caliper or support parts for the brake linings are required. This not only reduces the assembly effort, but also results in a reduced weight.

FIG. 4 shows an embodiment of the disc brake in accordance with the invention as a pre-assembled module. It shows the brake support 10 with the actuation device 48 attached thereto. It also shows the above-mentioned brake caliper 50, which is movably attached to the brake support 10 via the sliding bolts 52 and 54. The brake lining 56 on the actuation side is already installed, but this is not absolutely necessary. The same applies to a pressure plate which could potentially be used.

The pre-assembled module shown in FIG. 4 may be attached as a whole to the axle assembly. Since the brake support 10 and the brake caliper 50 have a considerable weight, especially in the case of brakes used in commercial vehicles, the projections 16 and 18 are especially useful because they can serve to (temporarily) hold the pre-assembled module on the axle assembly.

The attachment of the pre-assembled module as shown in FIG. 4 in one process step constitutes a significant simplification as compared to conventional disc brakes, which, as a rule, require that the individual parts shown in FIG. 4 be attached individually and one after the other.

Following the installation of the module shown in FIG. 4 to the axle assembly, the brake disc 46 is installed. Then the brake lining on the wheel rim side is installed.

FIG. 5 shows the completed disc brake. The brake lining on the wheel rim side is identified by the reference number 58. A brake cylinder has the reference number 60.

The brake lining 58 on the wheel rim side is preferably installed in the caliper 50 through an opening 62, which results in the above-mentioned option for mounting the module shown in FIG. 4 in one process step. The same considerations which apply to brake lining 58 on the wheel rim side also apply to the brake lining 56 on the actuation side as well as, possibly, a pressure plate. It, too, can be installed as well as deinstalled through the caliper opening 62, which is of great significance, in particular with respect to the simplification of the change of brake lining.

FIG. 6 shows the same brake as shown in FIG. 5, but in a side view, which again reveals the relative position of the individual elements to each other.

FIG. 7 clearly shows once again that the brake support (cut off at the bottom portion) is plate-shaped overall, apart from the projections 16 and 18, which, however, are located on the side facing away from the brake disc, which is why the brake support does not exhibit any parts which extend over or even behind the brake disc.

A pressure plate 64, shown in FIG. 7, serves to facilitate the introduction of brake application forces which are applied via a brake application element 66. The pressure plate 64 shows a projection 68 for the purpose of hanging it into the guide groove 20.

FIG. 8 shows the same view as FIG. 4, but for an embodiment in which the flange surface 12 does not have a ring-shaped, closed design but instead is interrupted by an opening 70, yielding overall an approximate “C” shape. The opening 70 allows the placement of the module shown in FIG. 8 onto an axle stub or the like in the transverse direction of the axis of rotation 24 of the brake, which achieves a further simplification of the assembly under certain circumstances. Due to the flanging from the outside, the installation can also be effected when the brake disc is already installed.

And finally, the following should be pointed out:

A combined consideration of FIG. 4 and 5 shows that the brake caliper 50 has four areas which, so to speak, surround the opening 62, i. e. a caliper leg 72 on the actuation side, a caliper leg 74 on the wheel rim side, a bridge area 76 on the inlet side, and a bridge area 78 on the outlet side.

The caliper leg 74 on the wheel rim side is twisted, with respect to the caliper leg 72 on the actuation side, about an axis that runs parallel to the axis of rotation 24, so that the two bridge areas 76 and 78 are twisted and especially the bridge area 78 on the disc outlet side is radially closer to the brake disc 46 than the bridge area 76 on the disc inlet side. This results in considerable mechanical advantages.

The characteristics of the invention disclosed in the above description, the claims as well as the drawing can be essential, both individually and in any combination, for the implementation of the invention in its various embodiments.

1-16. (canceled)

17. A disc brake having a brake disc, said disc brake comprising:
a brake caliper;
a brake support, wherein the brake support has no parts that, when the disc brake is in an assembled state, extend over the brake disc and/or extend into and/or over a rotation contour of the brake caliper; and
at least one brake lining, wherein the brake caliper has an opening allowing the brake lining to pass through for assembly and disassembly.

18. The disc brake of claim 17, wherein one of said at least one brake lining is supported and guided by the brake support.

19. The disc brake of claim 17, wherein the brake support has a flange surface adapted for attachment to an axle assembly, wherein the flange surface is formed in an area that encloses an axis of rotation of the brake disc in a closed contour form.

20. The disc brake of claim 19, wherein the flange surface is located on a side of the brake support facing away from the brake disc.

21. The disc brake of claim 20, further comprising at least one recess in the flange surface.

22. The disc brake of claim 21, wherein the recess is configured to accommodate an attachment screw or a sensor.

23. The disc brake of claim 17, wherein the brake support exhibits a flange surface for attachment to an axle assembly, wherein the flange surface is formed in an area that provides a recess for placement onto an axle stub in a transverse direction of an axis of rotation.

24. The disc brake of claim 23, wherein the flange surface is located on a side of the brake support facing away from the brake disc.

25. The disc brake of claim 24, further comprising at least one recess in the flange surface.

26. The disc brake of claim 25, wherein the recess is configured to accommodate an attachment screw or a sensor.

27. The disc brake of claim 17, wherein the brake support comprises an attachment device for the detachable attachment of a guiding device for guiding the brake caliper.

28. The disc brake of claim 27, wherein the attachment device has at least one recess to accommodate a guiding element.

29. The disc brake of claim 27, wherein the guiding device comprises at least one guide bolt.

30. The disc brake of claim 17, further comprising at least one guide projection located on a side of the brake support facing away from the brake disc and serving to guide a brake pressure plate.

31. The disc brake of claim 30, wherein at least one of said at least one guide projection comprises a guide groove.

32. The disc brake of claim 17, wherein said brake support comprises a first guide projection on a disc inlet side of the brake support and a second guide projection on a disc outlet side of the brake support.

33. The disc brake of claim 17, wherein said brake support comprises a stop to limit movement of the brake caliper in an axial direction of the brake disc.

34. The disc brake of claim 17, wherein the brake caliper comprises two caliper legs located on opposite sides of the brake disc and a connection device connecting the two caliper legs to each other, wherein the connecting device is radially closer to the brake disc on a brake disc outlet side than on a brake disc inlet side at least in an area in which the connecting device extends over the brake disc.

35. The disc brake of claim 17, wherein said at least one brake lining comprises a wheel rim side brake lining coupled to the brake caliper such that the brake caliper transmits braking forces from the wheel rim side brake lining to the brake support.

36. The disc brake of claim 17, wherein the brake support is made of one piece of material.
